(19) United States
(12) Patent Application Publication
(10) Pub. No.: US 2019/0030437 A1
(43) Pub. Date: Jan. 31, 2019

(54) OFFLINE IN-GAME GIFTING

(71) Applicant: Zynga Inc., San Francisco, CA (US)

(72) Inventors: Muthukaleeeshwaran Subbiah, Bangalore (IN); Sudhaharan Sam, Bangalore (IN); Rajiv Golay, Bangalore (IN); Rongsentemshi Jamir, Nagaland (IN); Bhavna Padmanabhan, Bangalore (IN); Kopparam Rama Keerthi Kumar, Bangalore (IN); Rahul Daga, Bangalore (IN); Anuj Khandelwal, Ajmer (IN)

(21) Appl. No.: 16/043,990

(22) Filed: Jul. 24, 2018

(30) Foreign Application Priority Data
Jul. 26, 2017 (IN) 201741026647

(51) Int. Cl. A63F 13/79; A63F 13/35; A63F 13/58

(52) U.S. Cl. CPC A63F 13/79; A63F 13/58; A63F 13/35

(57) ABSTRACT

A computer implemented method comprising:
generating, by a first client device executing a game in an off-line mode, a request for a virtual object from a second client device;
sending the request for the virtual object, by the first client device, using an off-line communication channel;
based on receiving a response including the requested virtual object from a second client device over the off-line communication channel, updating a game state for the game on the first client device to indicate receipt of the virtual object from the second client device, and updating a social network state between a first user associated with the first client device and a second user associated with the second client device.

### CLAIM OF PRIORITY

This application claims priority to Indian Application Serial No. 201741026647, filed on Jul. 26, 2017, which is incorporated herein by reference in its entirety.

### BACKGROUND

Games are popular applications for personal client devices such as laptops, tablets, smart phones, wearable devices (e.g., watches, head-mounted displays, etc.), and other client devices. Some of the more popular games include social elements that enable a user to interact with other users within the games. These types of games typically require an Internet connection to facilitate social interactivity between users. Providing Internet connectivity on personal client devices, however, can be costly for users because network providers for personal client devices oftentimes charge for Internet access by the amount of data sent and received by the devices. Operating personal client devices on-line may also be computing resource-intensive because of the amount of processing, memory, storage, network, power, and other resources utilized to support such operation. In particular, it may be especially prohibitive to run a game requiring an Internet connection on a personal client device because of how quickly the game can drain the device's battery.

### BRIEF DESCRIPTION OF THE DRAWINGS

The present disclosure will describe various embodiments with reference to the drawings, in which:

FIG. 1A, FIG. 1B, and FIG. 1C illustrate examples of user interfaces of a game that supports off-line in-game requests for gifts in accordance with an example embodiment;

FIG. 2A, FIG. 2B, and FIG. 2C illustrate examples of user interfaces of a game that supports off-line in-game gifting in accordance with an example embodiment;

FIG. 3A illustrates an example of a process for sending off-line in-game requests for gifts in accordance with an example embodiment;

FIG. 3B illustrates an example of a process for generating a request for gifts in accordance with an example embodiment;

FIG. 4 illustrates an example of a process for off-line in-game gifting in accordance with an example embodiment;

FIG. 5A illustrates an example of a network environment in accordance with an example embodiment;

FIG. 5B illustrates an example of a network environment in accordance with another example embodiment;

FIG. 6 illustrates an example of a game management system in accordance with an embodiment;

FIG. 7 illustrates an example of a social network in accordance with an embodiment;

FIG. 8 illustrates an example of data flow between a game management system and a social network in accordance with an embodiment; and

FIG. 9 illustrates an example of a computing system in accordance with an embodiment.

### OVERVIEW

Systems and methods in accordance with various embodiments of the present disclosure may overcome one or more of the aforementioned and other deficiencies experienced in conventional approaches for facilitating social interactivity via games for portable client devices. For example, some embodiments enable users on separate client devices to interact with one another within a game even when one or more of the client devices are disconnected from the Internet or otherwise executing the game off-line. A client device is executing the game off-line when the client device is executing the game but is not in communication with a game server managing the game.

In some embodiments, a first client device executing a game in an off-line mode may receive a request for a gift, a virtual object, or other in-game asset from a second client device. The first client device can periodically broadcast the request using various off-line communication channels. An off-line communication channel is a communication channel that is not supported by the network (e.g., the internet). Off-line communication channels can be based on Hotspot, Wireless Fidelity (Wi-Fi) Peer to Peer (P2P) or Wi-Fi Direct, Bluetooth or Bluetooth Low Energy (BLE), the Infrared Data Association (IrDA) specifications or other wireless optical communications, ultra-wideband (UWB) radio technology, near-field communications (NFC), radio-frequency identification (RFID), and ultrasonic or other sonic communications, or other suitable communication channel. If there are other client devices within the vicinity, the first client device may receive a response from one or more of those devices that include the requested virtual object. At that point, the first client device may update a game state to reflect receipt of the requested virtual object.

In some embodiments, a first client device executing a game in an off-line mode may receive a request to send a gift, a virtual object, or other in-game asset to a second client device. The first client device can determine one or more off-line communication channels for sending a response to the client device, such as one or more of the technologies discussed above. The first client device may then periodically send a response including the requested virtual object over the one or more off-line communication channels until the first client device receives acknowledgement of receipt of the requested virtual object from the second client device.

In some embodiments, the off-line interactions between multiple client devices may result in one or more updates to social network states of the users of the devices. For example, a first user receiving a virtual object from a second user and/or the second user sending the virtual object to the first user may enable the first user to add the second user to the first user's social network(s) (e.g., an out-of-game social network and/or an in-game social network) and/or the second user to add the first user to the second user's social network(s). As another example, the off-line interactions between multiple client devices can result in the adjustment of social interactivity measurements related to gameplay (e.g., to overcome a game obstacle), a relationship status between users (e.g., promoting an nth degree friendship to an n−1 degree relationship), or a personal social network status (e.g., increasing a user's karma score).

The present disclosure describes various other functions and advantages below in accordance with the various embodiments.

### DETAILED DESCRIPTION

Computer games often provide for gameplay in which a client device executing a game receives user input for user-controlled gameplay actions via a game interface that includes at least part of a gameboard. The gameboard can comprise a virtual world or some other imagined playing space in which a user controls one or more player characters and/or virtual game objects. In other computer games (e.g., card-based games, board games, and word games), gameplay may not necessary include control or representation of any player characters.

Many computer games operate within and/or in cooperation with an online social networking system. Such an online social networking system may allow both users and other parties to interact with the computer games directly, whether to play the games or to retrieve game- or user-related information. Internet users may maintain one or more accounts with various service providers, including, for example, online game management systems and online social networking systems. Online systems can typically be accessed via devices using web browser clients (e.g., Firefox, Chrome, Internet Explorer) or standalone applications or “apps” associated with the systems.

In many computer games, there can be various types of in-game assets that a player character can obtain within the game. For example, a player character may acquire game points, gold coins, experience points, character levels, character attributes, virtual cash, game keys, or other in-game items of value. In many computer games, there can also be various types of in-game obstacles that a player must overcome to advance within the game. In-game obstacles can include missions, tasks, puzzles, opponents, levels, gates, actions, etc. In some games, a goal of the game may be to acquire certain in-game assets, which can then be used to complete in-game tasks or to overcome certain in-game obstacles. For example, a user may be able to acquire a virtual key (i.e., the in-game asset) that can then be used to open a virtual door (i.e., the in-game obstacle).

A client device can display a representation of the gameboard. In this respect, the gameboard is to be understood as the in-game environment in which gameplay occurs. For example, the gameboard of a word game can be a grid of blocks populated with letters, the gameboard of a chess game may be a virtual representation of a chessboard, and in a game such as Farmville, the gameboard may comprise a virtual in-game world or environment within which user-controlled player characters are movable to perform various in-game actions with respect to other characters and/or in-game objects located within the virtual world or environment. A game engine can accept inputs from the user, determine in-game actions, and decide outcomes of events.

The performance of gameplay actions, in-game social interaction with other players, in-game cooperation with players in a common guild or alliance, and other game-related actions are typically performed on a client device via user interaction with corresponding user interface elements forming part of the game user interface. Generation of the game user interface on a client device to permit such actions is typically achieved by launching or executing a corresponding game application on the client device.

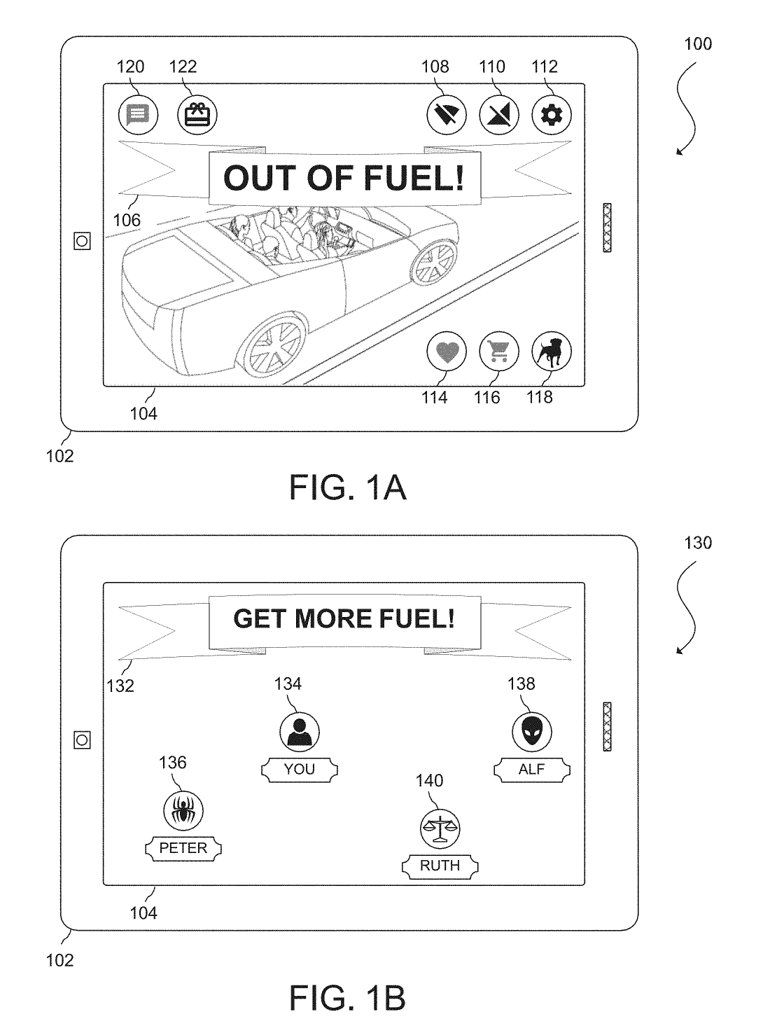

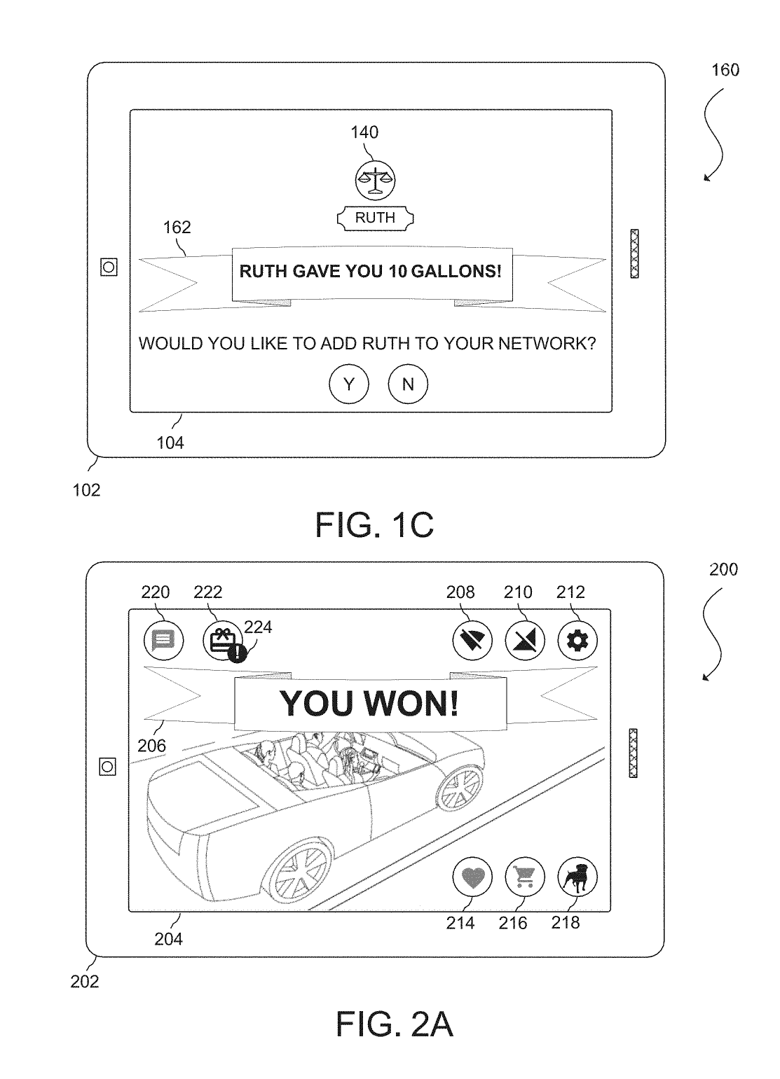

FIG. 1A, FIG. 1B, and FIG. 1C show examples of user interfaces of a game that enables a user to request for gifts, virtual objects, or other in-game assets from other users while one or more users execute the game in an off-line mode. One of ordinary skill in the art will appreciate that this set of user interfaces is but one example for supporting off-line in-game requests for gifts and that other embodiments may include fewer or more elements without departing from the scope of the present disclosure. In user interface 100 of FIG. 1A, client device 102 (e.g., tablet, smartphone, or other client device) displays on touchscreen 104 a frame of an end state of a game executing on client device 102. Banner 106 indicates that the player character has run out of fuel. User interface 100 also comprises a number of other user interface elements, including Wi-Fi network status icon 108, cellular network status icon 110, settings icon 112, rating icon 114, shopping icon 116, game information icon 118, messaging icon 120, and gifting icon 122. Wi-Fi network status icon 108 and cellular network status icon 110 indicate that client device executes the game in an off-line mode as both Wi-Fi network connectivity and cellular network connectivity are unavailable or turned off (such as by configuring settings for the game via settings icon 112 or by use of a native operating system of the device 100).

In this example, certain user interface elements of user interface 100 are grayed out, such as rating icon 114 which enables a user to rate the game upon selection of the icon, shopping icon 116 which enables the user to purchase additional in-game objects within the game, and messaging icon 120 which enables the user to send a message to one or more of the user's contact. These functions—rating, shopping, and messaging—may require an Internet connection such that they are currently unavailable. Gifting icon 122, however, is not grayed out, indicating that the user may request a gift, virtual object, or other in-game asset from another user despite the fact that the client device is executing the game in an off-line gaming mode. “Off-line gaming mode” means that the client device is executing the game but is not in communication with the game server, for example because the client device has no internet connection. The client device may in some cases be in an off-line gaming mode with a Wi-Fi connection, for example where the Wi-Fi connects to a local network that is not connected to the Internet.

Client device 102 may display user interface 130 of FIG. 1B, a gift requesting interface as indicated by banner 132, in response to the user selecting gifting icon 122. User interface 130 also shows first avatar icon 134 associated with the user, second avatar icon 136 associated with a user named “Peter,” third avatar icon 138 associated with a user named “Alf,” and fourth avatar icon 140 associated with a user named “Ruth.” In this example, the relative position of the various avatar icons can indicate the relative physical position of client device 102 to the client devices (not shown) associated with Peter, Alf, and Ruth.

Client device 102 may display user interface 160 of FIG. 1C, a gift received interface as indicated by banner 162, in response to the user selecting fourth avatar icon 140. Client device 102 can update a game state of the game to reflect receipt of the gift from Ruth. In some embodiments, the game can also include a syncing component to sync the off-line game state with an on-line game state. In particular, syncing the on-line game state maintained at the game server based on the off-line game state maintained at the client device(s) can be automatic upon reconnecting to the internet. User interface 160 also shows user interface elements for enabling the user to add Ruth to one or more of the user's social networks. In other embodiments, social network status updates can also include adjustments of social interactivity measurements related to gameplay, relationship statuses between users, or the user's social network status.

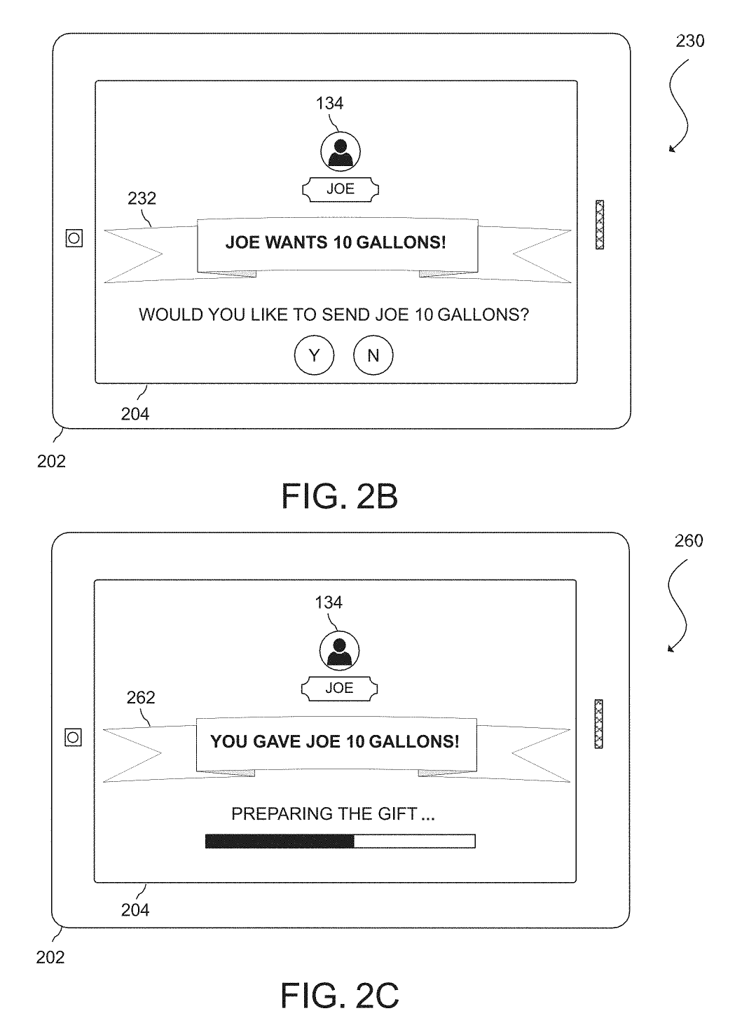

FIG. 2A, FIG. 2B, and FIG. 2C show examples of user interfaces of a game that enables a user to send gifts, virtual objects, or other in-game assets to other users while one or more users execute the game in an off-line mode. User interfaces 200, 230, and 260 may be complementary to user interfaces of 100, 130, and 160. For example, client device 202 may be associated with the user Ruth and client device 202 may display user interface 200 in response to client device 102 sending the request for the gift via selection of gifting icon 122 and client device 202 may display user interface 230 in response to a selection received by client device 102 for fourth avatar icon 140 (i.e., Ruth) to provide the gift.

In user interface 200 of FIG. 2A, client device 202 displays on touchscreen 204 a frame of an end state of a game executing on client device 202. Banner 206 indicates that the user associated with client device 202 (i.e., Ruth) has won the game. The game may reward Ruth with points, additional fuel, or other in-game assets for her victory. User interface 200 also comprises a number of other user interface elements, including Wi-Fi network status icon 208, cellular network status icon 210, settings icon 212, rating icon 214, shopping icon 216, game information icon 218, messaging icon 220, and gifting icon 222. These icons can provide similar status information and functions as counterpart icons 108, 110, 112, 114, 116, 118, 120, and 122. However, user interface 200 also includes notification badge 224 indicating that client device 202 has received a request for a gift.

Client device 202 may display user interface 230 of FIG. 2B, a gift sending interface as indicated by banner 232, in response to Ruth selecting notification badge 224. User interface 230 also shows first avatar icon 134 associated with a user of client device 102 (i.e., “Joe”) and “Y” or “N” user interface elements for enabling Ruth to accept or reject Joe's request. In this example, Ruth elects to send the gift to Joe as shown in user interface 260 of FIG. 2C, a gift sent interface as indicated by banner 262. User interface 260 also includes a progress bar indicating how far along client device 202 has progressed in preparing the gift.

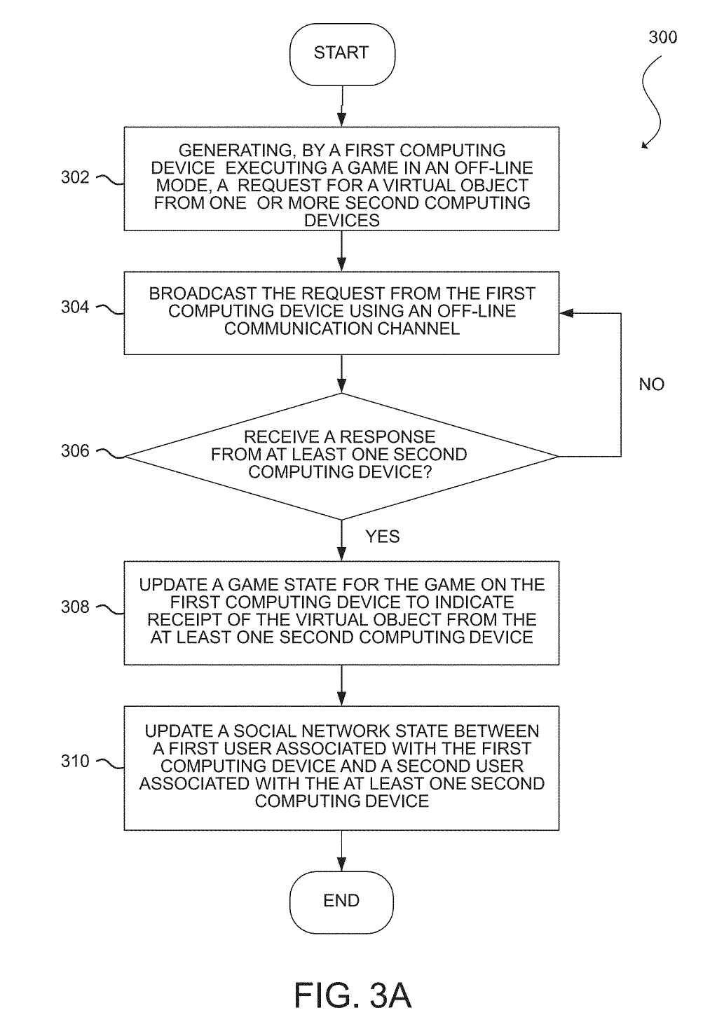

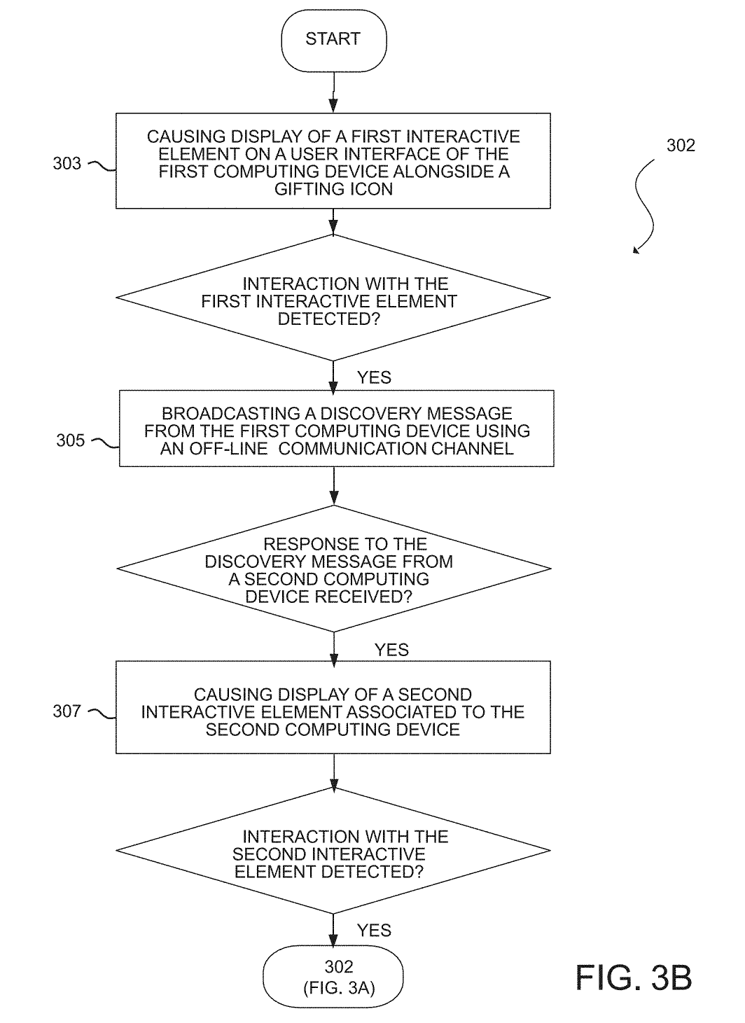

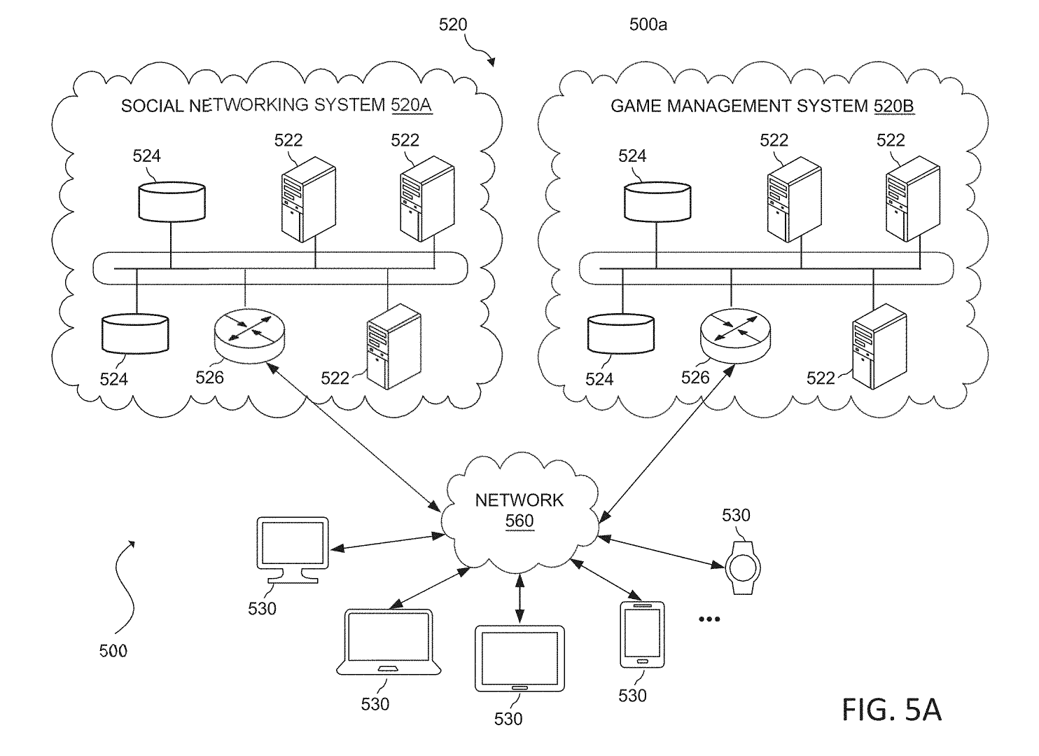

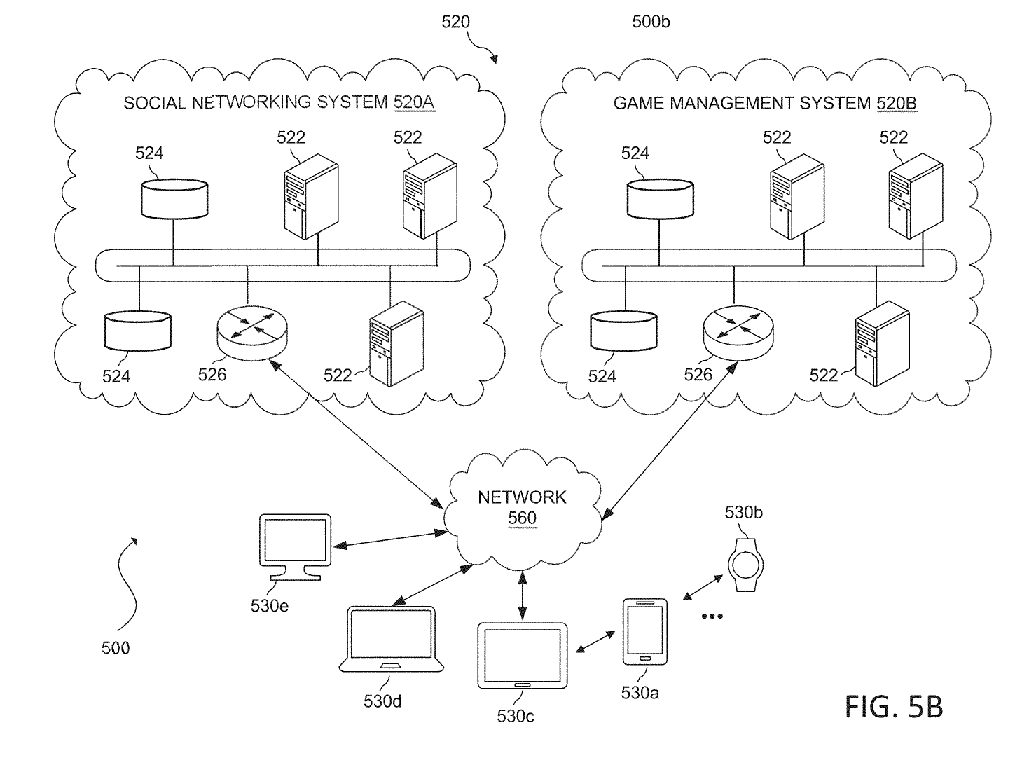

FIG. 3A shows an example of a process 300 for sending a request for a gift from a first client device executing a game in an off-line mode. The first client device may be implemented as client device 503a of FIG. 5B. For any process discussed herein, there can be additional, fewer, or alternative steps performed in similar or alternative orders, or in parallel, within the scope of various embodiments unless otherwise stated. Process 300 can begin at step 302 in which the first client device generates a request for a virtual object (i.e., a gift or in-game asset), for a game executed on the first client device in the off-line mode, from one or more second client devices. The first client device executes an off-line communication protocol. The second client devices are concurrently executing the off-line communication protocol. In some embodiments, the second client devices may be concurrently executing the game on-line or off-line. In other embodiments, the second client devices may execute the off-line communication protocol in a background mode to facilitate social interactivity within the game despite one or more of the client devices operating the game off-line. The second client devices may be implemented as client device 503b or 503c of FIG. 5B, client device 503b being an implementation of a second computing device executing the game off-line and client device 503c being an implementation of a second computing device executing the game on-line. In some embodiments, the request for a virtual object is generated upon detecting a user interaction with a first interactive element displayed on the user interface of the first client device (e.g., the gifting icon 122 described in relation to FIG. 1A).

FIG. 3B shows an example of a process 302 for generating the request for a virtual object. At step 303, the first interactive element (e.g., the gifting icon 122 described in relation to FIG. 1A) is displayed on the user interface of the first client device. Upon detecting a user interaction with the first interactive element, the first client device performs a scan for nearby second client devices concurrently executing the off-line communication protocol. The scan may be performed by broadcasting a discovery message using the off-line communication channel, at step 305. Nearby client devices executing the off-line communication protocol respond with a response message that may include information like a user name of the user associated to the second client device and a location of the second client device. At step 307, the first client device displays a second interactive element (e.g. an avatar icon 134, 136, 138, 140 described in relation to FIG. 1B) for each of the second client device from which a response message was received. Each interactive element may be displayed alongside the user name that was included in the response message. A relative position of the interactive element on the user interface may indicate the relative physical position of the second client device to the first client device, based on the position of the second client device included in the response message. The request for the virtual object is then generated (step 302 described in relation to FIG. 3A) based on detecting a user interaction with one or more of the second interactive element(s).

In reference to FIG. 3A, process 300 can continue to step 304 in which the first client device sends the request for the virtual object using one or more off-line communication channels, such as such as those based on Hotspot, Wi-Fi P2P or Wi-Fi Direct, Bluetooth or BLE, IrDA specifications or other wireless optical communications, UWB radio technology, NFC, RFID, ultrasonic or other sonic communications, and/or other suitable communication channels. The request for the virtual object might be broadcasted. If the user has selected one or more second client device(s) by interacting with one or more of the second interactive element(s), the request for the virtual object might alternatively be sent as a unicast (or multicast) message to the selected second client device(s).

A hotspot is typically a location in which devices may acquire Internet access using Wi-Fi technology, via a wireless local area network (WLAN) provided using a router connected to an Internet service provider (ISP). Many client devices can also operate as Hotspots for other devices by providing those other devices with Internet access via a cellular network connection or other Internet connection available on the Hotspot-providing device. In some embodiments, the first client device can leverage its Hotspot functionality to support off-line social interactions within a game. For example, the first client device can configure itself to operate as a Hotspot with an encrypted Hotspot name that is only available to the game. One or more second client devices within a predetermined range of the first client device (e.g., a Wi-Fi range or other specified range) can perform a Wi-Fi scan to identify any Hotspots available to those devices. When one or more of those devices identify the encrypted Hotspot host, the device(s) can join the Hotspot. Upon successful connection to the Hotspot, the second client device(s) can establish a socket connection with the first client device to exchange data, including gifts, virtual objects, or in-game assets.

In some embodiments, client devices may use Wi-Fi P2P for implementing the off-line in-game communication protocol. Wi-Fi P2P allows certain devices (e.g., devices operating the Android mobile operating system) with suitable hardware to connect directly to one another via Wi-Fi without an intermediate access point. Wi-Fi P2P application programming interfaces (APIs) can include methods that allow a client device to discover, request, and connect to peers; listeners that notify the client device of the success or failure of the discovery, request, and connection methods; and intents that notify the client device of specific events, such as dropped events or newly discovered peers.

In some embodiments, client devices may use Bluetooth or BLE for implementing the off-line in-game communication protocol. Bluetooth or BLE is a personal area network (PAN) technology managed by the Bluetooth Special Interest Group (SIG) and defined within IEEE 802.15.1. Bluetooth operates in the 2.4-Hz industrial, scientific, and medical (ISM) band and uses frequency-hopping spread spectrum with Gaussian frequency shift keying (GFSK), differential quadrature phase shift keying (DQPSK), or eight-phase-shift differential phase-shift keying (8DPSK) modulation. The basic data gross rate is 1 Mbit/s for GFSK, 2 Mbits/s for DQPSK, and 3 Mbits/s for 8DPSK. There are also three power classes of 0 dBm (1 mW), 4 dBm (2.5 mW), and 20 dBm (100 mW), which essentially determines range. The standard range is about 10 meters and up to 100 meters at maximum power with a clear path.

In some embodiments, client devices may use infrared or other wireless optical technology for implementing the off-line in-game communication protocol. Infrared wireless technology uses light instead of radio for its connectivity. Infrared is low-frequency, invisible light that can serve as a carrier of high-speed digital data. The primary wavelength range is 850 to 940 μm. The transmitter(s) can be IR LED(s), and the receiver(s) can be diode photodetector(s) and amplifier(s). The light wave is usually modulated with a high-frequency signal that is, in turn, coded and modulated by the digital data to be transmitted.

There is a separate standard for data transmission called IrDA. The Infrared Data Association (IrDA) sets standards for infrared data transmissions and maintains the IrDA specifications. IrDA exists in many versions mainly delineated by their data rate. Data rates range from a low of 9.6 to 115.2 kbits/s in increments to 4 Mbits/s, 16 Mbits/s, 96 Mbits/s, 512 Mbits/s to 1 Gbit/s, and 5 and 10 Gbits/s.

In some embodiments, client devices may also use one or more of UWB radio technology, NFC, RFID, or ultrasonic or other sonic communication channels for implementing the off-line in-game communication protocol.

At decision point 306, the first client device can determine whether it has received a response for the request for the gift. If there is no response, the first client device may return to step 304. At each new step 304, the first client device may send the request for the virtual object using the same or another off-line communication channel. If there is a response, the first client device can process the response to update, at operation 308, a game state for the game to indicate receipt of the virtual object from the gifting client device. The game state can be immediately updated on the first client device. If the first client device was in an off-line gaming mode, the game state can be synced on the game server side, as soon as the first client device reconnects to the internet, based on the updated game state stored on the first client device. If the first client device was in an on-line gaming mode, the game state can be immediately updated on the game server.

At step 310, the first client device may update a social network state between the user of the first client device and the user(s) of the gifting client device(s). As discussed, updating the social network state can include adding the user of the first client device to a social network of the user(s) of the gifting client device(s) and/or adjusting social interactivity measurements related to gameplay (e.g., to overcome a game obstacle), a relationship status between users (e.g., promoting an nth degree friendship to an n−1 degree relationship), or a personal social network status (e.g., increasing a user's karma score). The social network state can be immediately updated on the first client device. If the first client device was in an off-line gaming mode, the social network state can be synced on the game server side, as soon as the first client device reconnects to the internet, based on the updated social network state stored on the first client device. If the first client device was in an on-line gaming mode, the social network state can be immediately updated on the social network server.

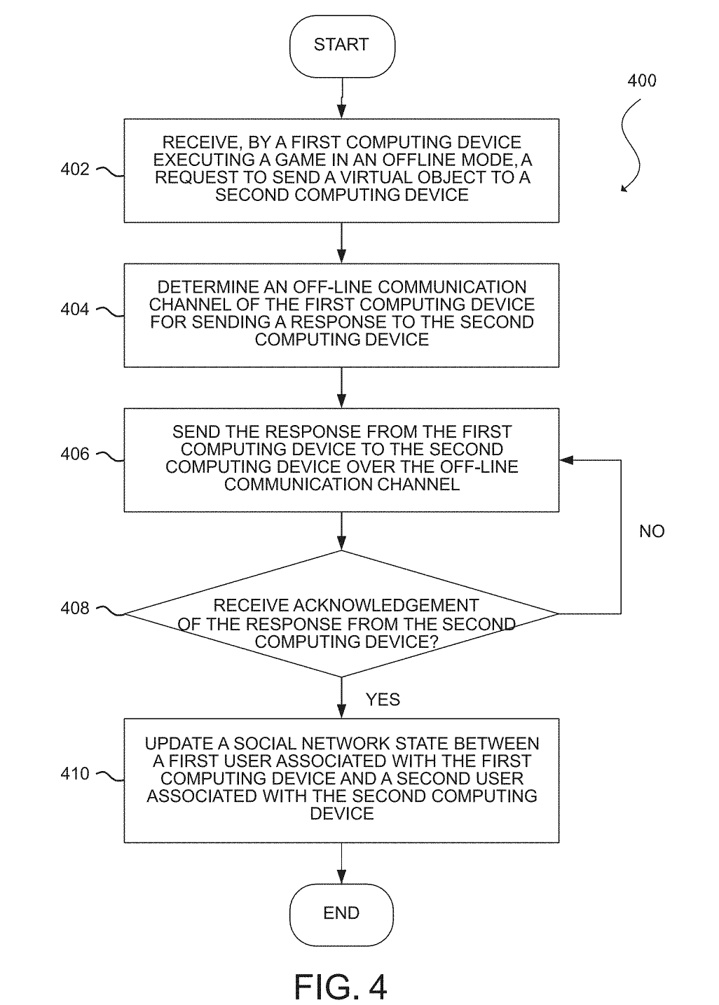

FIG. 4 shows an example of a process 400 for sending a gift from a first client device executing a game in an off-line mode to a second client device. Process 400 can begin at step 402 in which the first client device receives a request to send a virtual object (i.e., a gift or in-game asset), for a game executed on the first client device in the off-line mode, to a second client device. In some embodiments, the first client device may be concurrently executing the game. In other embodiments, the first client device may execute an off-line communication protocol in a background mode to facilitate social interactivity within the game despite one or more of the client devices operating the game off-line.

Process 400 can continue to step 404 in which the first client device determines one or more off-line communication channels for sending a response to the second client device. As discussed above, these off-line communication channels can be based on Hotspot, Wi-Fi P2P or Wi-Fi Direct, Bluetooth or BLE, IrDA specifications or other wireless optical communications, UWB radio technology, NFC, RFID, ultrasonic or other sonic communications, and/or other suitable communication channels.

Process 400 can proceed to step 406 in which the first client device sends the response, including the gift, to the second client device over the one or more off-line communication channels. At decision point 408, the first client device may wait for acknowledgement of the of the response from the second client device. If there is no response, the first client device can return to step 406. If there is a response, the first client device can update a social network state between the users of the first and second client devices. The social network state can be immediately updated on the first client device. If the first client device was in an off-line gaming mode, the social network state can be synced on the game server side, as soon as the first client device reconnects to the internet, based on the updated social network state stored on the first client device. If the first client device was in an on-line gaming mode, the social network state can be immediately updated on the social network server.

The first client device can also process the response to update, a game state for the game to indicate transfer of the virtual object to the receiving client device. The game state can be immediately updated on the first client device. If the first client device was in an off-line gaming mode, the game state can be synced on the game server side, as soon as the first client device reconnects to the internet, based on the game state stored on the first client device. If the first client device was in an on-line gaming mode, the game state can be immediately updated on the game server.

### Examples of Architectures for Social Networking Systems and Game Management Systems

FIG. 5A shows network environment 500a, an example of an environment for implementing systems and methods discussed in the present disclosure. For any system or system element discussed herein, there can be additional, fewer, or alternative components arranged in similar or alternative orders, or in parallel, within the scope of the various embodiments unless otherwise stated. In this example, network environment 500a includes social networking system 520A, game management system 520B (i.e., an online gaming system), client system 530 (of which computing device 200 of FIGS. 1A-1C and 2A-2C may be an embodiment), and network 560. The components of network environment 500a can be connected to each other in any suitable configuration, using any suitable type of connection. The components may be connected directly or over network 560, which may be any suitable network. For example, one or more portions of network 560 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

FIG. 5B shows network environment 500b, another example of an environment for implementing systems and methods discussed in the present disclosure. The network environment 500b described in relation to FIG. 5B is similar to the network environment 500a of FIG. 5A except that, two of the client devices 530a, 530b are disconnected from the network 560, while the other client devices 530c-530e are connected to the network 560. Client device 530a (of which client device 102 of FIGS. 1A-1C may be an embodiment) is connected over an off-line communication channel (e.g., a Bluetooth connection) with client device 530b and client device 530c (of which client device 202 of FIGS. 2A-2C may be an embodiment).

Social networking system 520A (i.e. social network system) is a network-addressable computing system that can host one or more social graphs. Social networking system 520A can generate, store, receive, and transmit social networking data. Social networking system 520A can be accessed by the other components of network environment 500a or 500b either directly or via network 760.

Game management system 520B is a network-addressable computing system that can host one or more online games. Game management system 520B can thus in some embodiments have multiple game engines and multiple game state databases for multiple respective games. Game management system 520B can generate, store, receive, and transmit game-related data, such as, for example, game account data, game input, game state data, and game displays. Game management system 520B can be accessed by the other components of network environment 500a or 500b either directly or via network 560. Client device 530 may access, send data to, and receive data from social networking system 520A and game management system 520B. Client system 530 can access social networking system 520A or game management system 520B directly, via network 560, or via a third-party system. As an example, client system 530 may access game management system 520B via social networking system 520A. Client system 530 can be any suitable client device, such as a personal computer, laptop, cellular phone, smart phone, computing tablet, etc.

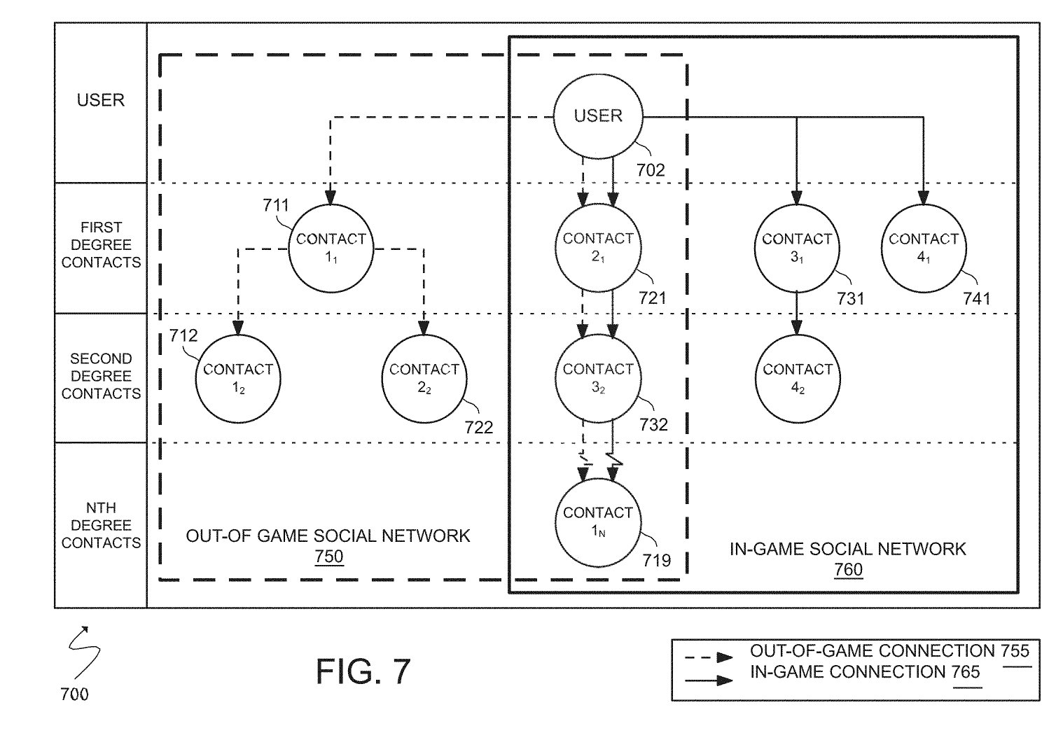

Although FIGS. 5A and 5B illustrate a particular number of social network systems 520A, game management systems 520B, client devices 530, and networks 560, this disclosure contemplates any suitable number of social network systems, game management systems, client systems, and networks. As an example, network environment 500a or 500b may include one or more game management systems 520B and no social networking systems 520A. As another example, network environment 500a or 500b may include a system that comprises both social networking system 520A and game management system 520B. Moreover, although FIG. 7 illustrates a particular arrangement for social networking system 520A, game management system 520B, client systems 530, and network 560, this disclosure contemplates any suitable arrangement of social networking system 520A, game management system 520B, client system 530, and network 560.

The components of network environment 500a or 500b may be connected to each other using any suitable connections. For example, suitable connections can include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In some embodiments, one or more connections each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. The connections need not necessarily be the same throughout network environment 500a or 500b. One or more first connections may differ in one or more respects from one or more second connections. Although FIGS. 5A and 5B illustrate particular connections between social networking system 520A, game management system 520B, client systems 530, and network 560, this disclosure contemplates any suitable connections between social networking systems, game management systems, client systems, and networks. As an example, in some embodiments, client systems 530 may have a direct connection to social networking system 520A or game management system 520B, bypassing network 560.

### Game Management Systems

In a computer game, a game engine can manage the game state of the game. In the examples of FIGS. 5A and 5B, the game engine may form part of game management system 520B. Game state comprises all game play parameters, including player character state, non-player character (NPC) state, in-game object state, game world state (e.g., internal game clocks, game environment), and other game play parameters. Each user may control one or more player characters (PCs). The game engine controls all other aspects of the game, including non-player characters (NPCs), and in-game objects. The game engine also manages game state, including player character state for currently active (online) and inactive (offline) players.

An online game can be hosted by game management system 520B. Game management system 520B can be accessed using any suitable connection with a suitable client system. A user may have a game account on game management system 520B, wherein the game account can contain a variety of information associated with the user (e.g., the user's personal information, financial information, purchase history, player character state, game state, etc.). In some embodiments, a user may play multiple games on game management system 520B, which can maintain a single game account for the user with respect to all the games, or multiple individual game accounts for each game with respect to the user. In some embodiments, game management system 520B can assign a unique identifier to each user of an online game hosted on game management system 520B. Game management system 520B can determine that a user is accessing the online game by reading the user's cookies, which may be appended to HTTP requests transmitted by client system 530, and/or by the user logging onto the online game.

In some embodiments, a user may access an online game and control the game's progress via client system 530 (e.g., by inputting commands to the game at the client device). Client system 530 can display the game interface and any push notifications, receive inputs from the user, transmitting user inputs or other events to the game engine, and receive instructions from the game engine. The game engine can be executed on any suitable system (such as, for example, client system 530, social networking system 520A, or game management system 520B). As an example, client system 530 can download client components of an online game, which are executed locally, while a remote game server, such as game management system 520B, provides backend support for the client components and may be responsible for maintaining application data of the game, processing the inputs from the player, updating and/or synchronizing the game state based on the game logic and each input from the player, and transmitting instructions to client system 530. As another example, each time the user provides an input to the game through the client system 530 (such as, for example, by typing on the keyboard or clicking the mouse of client system 530), the client components of the game may transmit the user's input to game management system 520B.

### Storing Game-Related Data

A database may store any data relating to game play within a game management system 520B. The database may include database tables for storing a player game state that may include information about the player's virtual gameboard, the player's character, or other game-related information. For example, user game state may include virtual objects owned or used by the user, placement positions for virtual structural objects in the user's virtual gameboard, and the like. User game state may also include in-game obstacles of tasks for the user (e.g., new obstacles, current obstacles, completed obstacles, etc.), player character attributes (e.g., character health, character energy, amount of coins, amount of cash or virtual currency, etc.), and the like.

The database may also include database tables for storing a user profile that may include information that is gathered from the user, the user's client device, or an affiliate social network. The user information may include the user's demographic information, the user's location information (e.g., a historical record of the user's location during game play as determined via a GPS-enabled device or the Internet Protocol (IP) address for the user's client device), the user's localization information (e.g., a list of languages chosen by the user), the types of games played by the user, and the like.

In some embodiments, the user profile may also include derived user information that may be determined from other information stored in the database. The derived user information may include information that indicates the user's level of engagement with the virtual game, the user's contact preferences, the user's reputation, the user's pattern of game-play, and the like. For example, game management system 520B may determine the user's contact preferences based on user attributes that the user's first-degree contacts have in common, and may store these user attributes as contact preferences in the user profile. Furthermore, game management system 520B may determine reputation-related information for the user based on user-generated content (UGC) from the user or the user's Nth degree contacts (e.g., in-game messages or social network messages), and may store this reputation-related information in the user profile. The derived user information may also include information that indicates the user's character temperament during game play, anthropological measures for the user (e.g., tendency to like violent games), and the like.

Integrated in-Game Advertising Platform

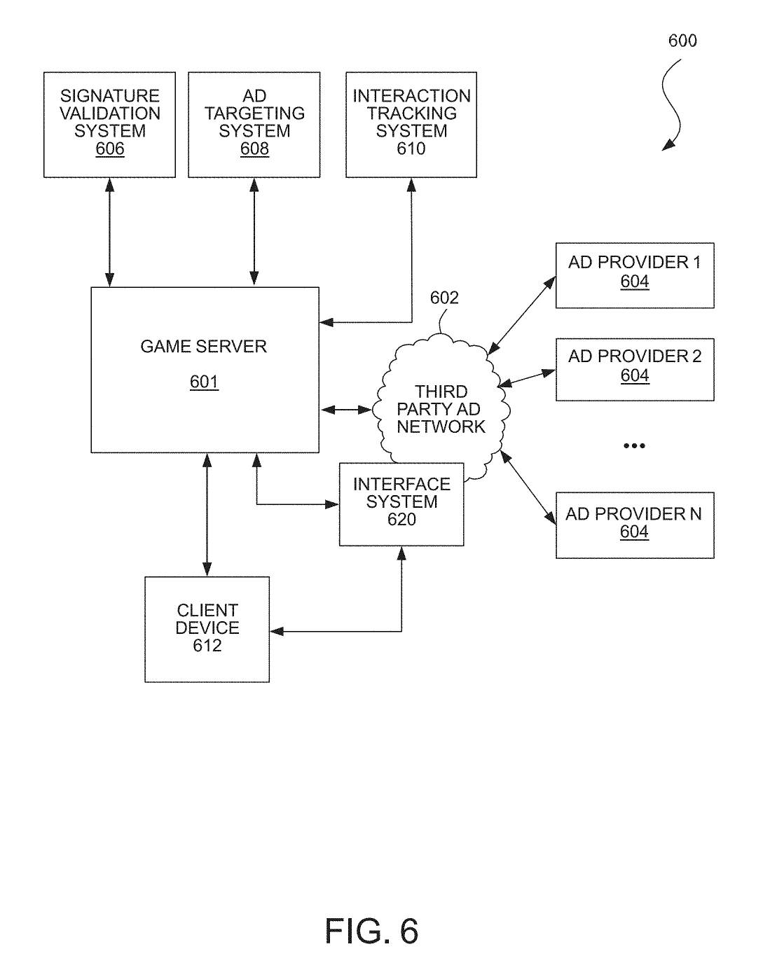

FIG. 6 shows in-game advertising platform 600 which may be integrated within a game management system, such as game management system 520B. In-game advertising platform 600 may include a game server 600 that communicates with a third-party advertisement network 602 that is configured to provide advertisements or other sponsored content from various sponsored content providers 604 (e.g., Ad Provider 1, Ad Provider 2, Ad Provider N), such as game sponsors and other sponsoring entities. Game server 601 and/or advertisement network 602 may provide advertisements and other sponsored content to client device 312, such as within or overlaying a game fiction of a game provided by game server 601.

Game server 601 may also communicate with various systems that perform methods associated with presenting advertisements and other sponsored content to users via their client devices 612, such as a signature validation system 606 configured to validate devices within the platform, an ad targeting system 608 configured to identify, target, and/or match advertisements to players viewing the advertisement, and/or an interaction tracking system 610 configured to track interactions between users via client device 612 and interactions with presented advertisements.

Once an online game is launched, game server 601 may initialize Flash based on an initUser transaction. Game server 601 can fetch targeting information from a targeting service, such as ad targeting system 608. At the same time or in parallel, game server 601 can initialize the online game code (e.g., game hypertext mark-up language (HTML) or JavaScript), by (1) fetching 3PAN playloads from a ZRuntime script, and (2) outputting an appropriate 3PAN payload into a page stream to create a 3PAN JavaScript module which can retrieve interactive content from third party advertisement network 602. At a trigger point or other condition, game server 601, via Flash, may identify available content. If available, game server 601 can present an option to view the content, and when the user selects the option, the 3PAN payload calls a load function with a pointer to the div/frame that is rendering the retrieved content. Upon completion of a presentation of the content, the 3PAN payload transmits a “completed message” to game server 601, and closes the content window. Game server 601 can then perform an action associated with the trigger point or condition by granting energy or performing other transactions within the game.

In some embodiments, displayed sponsored content may be in a rich-media format, and include a video piece along with a survey or quiz questions, although in some cases, the advertisements may include arbitrary web content (pure video, display only, rich media, and so on). In some example embodiments, game server 601 may utilize an IFrame window triggered from a Flash or HTML5 game client as the content placement mechanism.

In some embodiments, a provider of interface system 620 may provide aa software development kit (SDK) that reduces in-game integration costs, among other things. The SDK may also provide uniform tracking and allow interface system 620 to manage and onboard new advertisement networks and/or content providers without game studio development involvement. The system may also integrate with a targeting engine, such as ad targeting system 608, providing the ability to target the promotional content of respective sponsored activities in a sequence of activities themselves, as well as target in-game placements to different player segments based on their geography, demographics, behavior, and so on.

In some embodiments, third party advertisement network 602 may provide a single and/or integrated interface, such as interface system 620, that includes components that perform various methods for presenting advertisements and other sponsored content to players of an online game, such as to resolve friction points within a game fiction or dialog, among other things.

### Social Networking Systems

In an online multiplayer game, users may control player characters (PCs), while the game engine can control non-player characters (NPCs) and game features, manage player character state and game state, and track the state for currently online users and currently off-line users. A player character can have a set of attributes and a set of contacts associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), etc. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each user.

In some embodiments, a user may access particular game instances of a game. A game instance is copy of a specific game play area that is created during runtime. In some embodiments, a game instance is a discrete game play area where one or more users can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific users) or non-exclusive (i.e., accessible by any user). In some embodiments, a game instance is populated by one or more player characters controlled by one or more users and one or more in-game objects controlled by the game engine. When accessing a game, the game engine may allow the user to select a particular game instance to play from a plurality of game instances. Alternatively, the game engine may automatically select the game instance that the user will access. In some embodiments, an online game comprises only one game instance that all users of the online game can access.

In some embodiments, a specific game instance may be associated with one or more specific users. A game instance is associated with a specific user when one or more game parameters of the game instance are associated with the specific user. As an example, a game instance associated with a first user may be named “First User's Play Area.” This game instance may be populated with the first user's PC and one or more in-game objects associated with the first user. In some embodiments, a game instance associated with a specific user may only be accessible by that specific user. As an example, a first user may access a first game instance when playing a game, and this first game instance may be inaccessible to all other user. In other embodiments, a game instance associated with a specific user may be accessible by one or more other users, either synchronously or asynchronously with the specific user's game play. As an example, a first user may be associated with a first game instance, but the first game instance may be accessible to all first-degree contacts in the first user's social network. In some embodiments, the game engine may create a specific game instance for a specific user when that user accesses the game. As an example, the game engine may create a first game instance when a first player initially accesses a game, and that same game instance may be loaded each time the first player accesses the game. As another example, the game engine may create a new game instance each time a first user accesses an online game, wherein each game instance may be created randomly or selected from a set of predetermined game instances. In some embodiments, the set of in-game actions available to a specific user may be different in a game instance that is associated with that user compared to a game instance that is not associated with that user. The set of in-game actions available to a specific user in a game instance associated with that user may be a subset, superset, or independent of the set of in-game actions available to that user in a game instance that is not associated with him. As an example, a first user may be associated with Blackacre Farm in a farming game. The first user may be able to plant crops on Blackacre Farm. If the first user accesses game instance associated with another user, such as Whiteacre Farm, the game engine may not allow the first user to plant crops in that game instance. However, other in-game actions may be available to the first user, such as watering or fertilizing crops on Whiteacre Farm.

In some embodiments, a game engine can interface with a social graph. Social graphs are models of connections between entities (e.g., individuals, users, contacts, contacts, player characters, non-player characters, businesses, groups, associations, concepts, etc.). These entities are considered “users” of the social graph; as such, the terms “entity” and “user” may be used interchangeably herein when referring to social graphs. A social graph can have a node for each entity and edges to represent relationships between entities. A node in a social graph can represent any entity. In some embodiments, a unique client identifier can be assigned to each user in the social graph. This disclosure assumes that at least one entity of a social graph is a user or player character in a game, though a social graph can include any suitable social graph users.

The minimum number of edges required to connect a first user (or player character) to a second user is considered the degree of separation between them. For example, where the two users are directly connected (one edge), they are deemed to be separated by one degree of separation. The first user would be a so-called “first-degree contact” of the second user and vice versa. Where the two users are connected through a third user (two edges), the two users are deemed to be separated by two degrees of separation. In this case, the first user would be a so-called “second-degree contact” of the second user. Where the two users are connected through N edges (or N−1 other users), the two users are deemed to be separated by N degrees of separation. Thus, the first user would be a so-called “Nth-degree contact.”

Within the social graph, each user (or player character) has a social network. A user's social network includes all users in the social graph within Nmax degrees of the user, where Nmax is the maximum degree of separation allowed by the system managing the social graph (such as, for example, social networking system 520A or game management system 520B). In one embodiment, Nmax equals 7, such that the user's social network includes only first-degree contacts. In another embodiment, Nmax is unlimited and the user's social network is coextensive with the social graph.

In some embodiments, the social graph is managed by game management system 520B. In other embodiments, the social graph is part of a social networking system, such as social networking system 520A managed by a third-party (e.g., Facebook, Contactster, Myspace). In yet other embodiments, a user can be associated with a social network on both game management system 520B and social networking system 520A, wherein the user can have a social network on game management system 520B that is a subset, superset, or independent of the user's social network on social networking system 520A. In such combined systems, game network system 520B can maintain social graph information with edge type attributes that indicate whether a given contact is an “in-game contact,” an “out-of-game contact,” or both. The various embodiments disclosed herein are operable when the social graph is managed by social networking system 520A, game management system 520B, or both.

FIG. 7 shows an example of a social network 700 that a social networking system, such as social networking system 520A, can maintain. As shown, user 702 can be associated, connected or linked to various other users, or “contacts,” within social network 700. These associations, connections or links can track relationships between users within social network 700 and are commonly referred to as online “contacts” or “friendships” between users. Each contact or friend in a particular user's social network within a social graph is commonly referred to as a “node.” For purposes of illustration, the details of social network 700 will be described in relation to user 702. As used herein, the terms “user” and “account” can be used interchangeably and can refer to any user in an online game management system or social networking system. As used herein, the term “contact” can mean any node within a user's social network.

As shown in FIG. 7, user 702 has direct connections with several contacts. When user 702 has a direct connection with another entity, that connection is referred to as a first-degree contact or relationship. In social network 700, user 702 has two first-degree contacts. That is, user 702 is directly connected to contact 11 711 and contact 21 721. In a social graph, it is possible for individuals to be connected to other individuals through their first-degree contacts (i.e., contacts of contacts). As described above, each edge required to connect a player to another user is considered the degree of separation. For example, FIG. 7 shows that user 702 has three second-degree contacts to which he is connected via his connection to his first-degree contacts. Second-degree contact 12 712 and contact 22 722 are connected to user 702 via his first-degree contact 11 711. The limit on the depth of contact connections, or the number of degrees of separation for associations, that user 702 is allowed is typically dictated by the restrictions and policies implemented by social networking system 520A.

In various embodiments, user 702 can have Nth-degree contacts connected to him through a chain of intermediary degree contacts as indicated in FIG. 7. For example, Nth-degree contact IN 719 is connected to user 702 via second-degree contact 32 732 and one or more other higher-degree contacts. Various embodiments may take advantage of and utilize the distinction between the various degrees of contacts relative to user 702.

In some embodiments, a user (or player character) can have a social graph within a game that is maintained by the game engine and another social graph maintained by a separate social networking system. FIG. 7 depicts an example of out-of-game social network 750 and in-game social network 760. In this example, user 702 has out-of-game connections 755 to a plurality of contacts, forming out-of-game social network 750. Here, contact 11 711 and contact 21 721 are first-degree contacts with user 702 in his out-of-game social network 750. User 702 also has in-game connections 765 to a plurality of users, forming in-game social network 760. Here, contact 21 721, contact 31 731, and contact 41 741 are first-degree contacts with user 702 in his in-game social network 760. In some embodiments, it is possible for a contact to be in both the out-of-game social network 750 and the in-game social network 760. Here, contact 21 721 has both an out-of-game connection 755 and an in-game connection 865 with user 702, such that contact 21 721 is in both user 702's in-game social network 760 and user 702's out-of-game social network 750.

As with other social networks, user 702 can have second-degree and higher-degree contacts in both his in-game and out of game social networks. In some embodiments, it is possible for user 702 to have a contact connected to him both in his in-game and out-of-game social networks, wherein the contact is at different degrees of separation in each network. For example, if contact 22 722 had a direct in-game connection with user 702, contact 22 722 would be a second-degree contact in user 702's out-of-game social network, but a first-degree contact in user 702's in-game social network. In some embodiments, a game engine can access out-of-game social network 750, in-game social network 750, or both.

In some embodiments, the connections in a user's in-game social network can be formed both explicitly (e.g., users must “contact” each other) and implicitly (e.g., system observes user behaviors and “contacts” users to each other). Unless otherwise indicated, reference to a contact connection between two or more users can be interpreted to cover both explicit and implicit connections, using one or more social graphs and other factors to infer contact connections. The contact connections can be unidirectional or bidirectional. It is also not a limitation of this description that two users who are deemed “contacts” for the purposes of this disclosure are not contacts in real life (i.e., in disintermediated interactions or the like), but that could be the case.

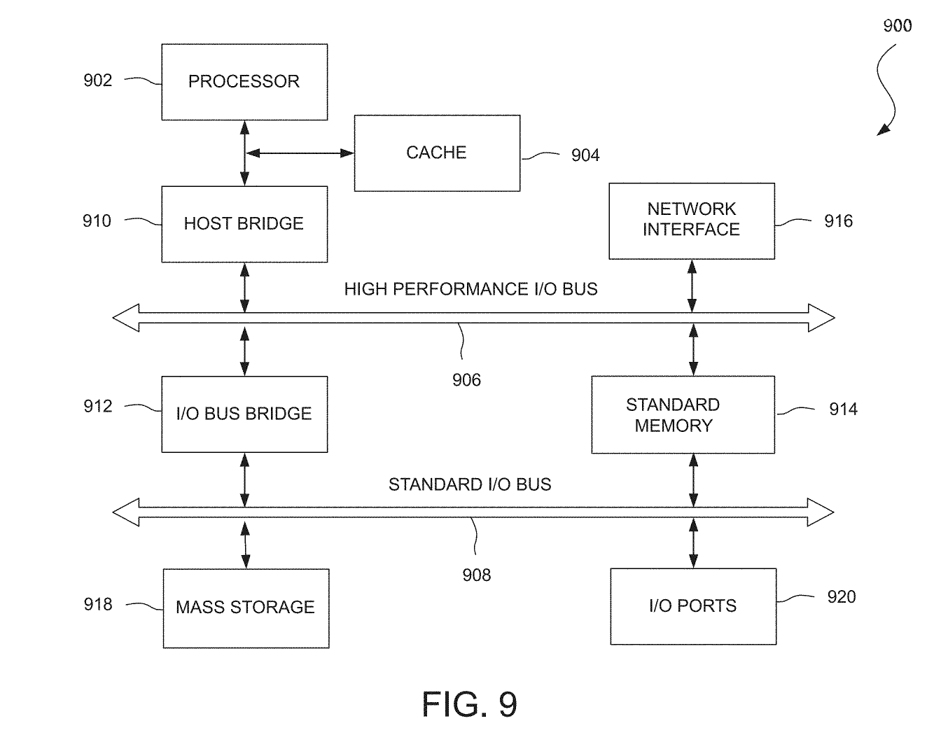

FIG. 9 shows a schematic view of an actionable notification system 904 that includes a number of hardware-implemented modules or arrangement for performing various automated procedures described with reference to the example embodiments of FIGS. 1-6. The functionalities of the system 904 and its respective components is briefly summarized immediately below. The various methodologies described herein are to be understood as being performed by use of the actionable notification system 904, thereby further to illustrate the configuration of system 904. As discussed previously, the actionable notification system 904 may in some embodiments be provided by a client device, such as the mobile phone 100. In other embodiments, the system 904 may be provided by server-site components, such as the example game management system 520B of FIG. 7. In a particular embodiment, the actionable notification system 904 forms part of the game management system 520B, being in communication with the game engine of the game management system 520B to receive information of game events that trigger actionable push notifications, and to prompt performance by the game engine of selected game actions responsive to user interaction with actionable push notifications surfaced on a client device (such as a mobile phone 100 of FIG. 1).

The system 904 includes a notification engine 910 for causing the presentation of actionable game-related push notifications (e.g., such as those described with reference to FIGS. 1-6) on a client device. The system 904 further includes an input interpreter 920 configured to receive and interpret input in the form of user-selection of a particular one of a plurality of game action elements forming part of respective push notifications.

The system 904 further includes a background action mechanism 930 configured to cause automated performance of a selected game-related action (e.g., such as those described with reference to FIGS. 1-6), without requiring launching of a corresponding game application and/or game user interface on the client device. In embodiments where the system 904 is provided by the client device, the background action mechanism 930 can be configured to cause performance of the selected game-related action by communicating the selected action to the online game engine, thereby to trigger automated implementation of the selected action by the game engine by modification of corresponding game state data. In embodiments where the system 904 is provided by one or more server-side device(s), the background action mechanism 930 may be configured to cause performance of the selected game action by implementing the selected action responsive to reception of a communication from the client device indicating selection of a particular game action element by the user.

The modules 910-930 are configured to communicate with each other (e.g., via a bus, shared memory, or a switch). Any one or more of the modules 910-930 described herein may be implemented using hardware (e.g., one or more processors of a machine) or a combination of hardware and software. For example, any module described herein may configure a processor (e.g., among one or more processors of a machine) to perform the operations described herein for that module. Thus, the modules may comprise circuitry formed dynamically by dynamic configuration of a reconfigurable processor through the execution of software code on the reconfigurable processor. Instead, or in addition, at least some of the modules may comprise permanently configured circuitry (e.g., an application specific integrated circuit) that is configured to perform the respective automated operations. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

### Data Flow

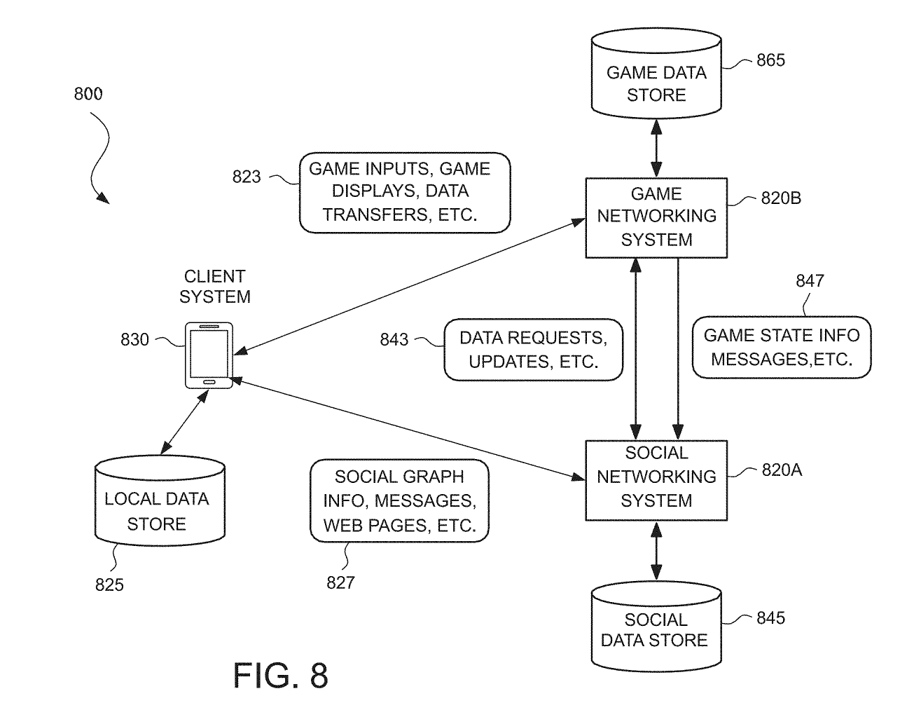

FIG. 8 illustrates an example of a data flow between the components of system 800, which can be an implementation of system 500a or 500b. In some embodiments, system 1000 can include client device 530, social networking system 520A (i.e., a social networking system), and game management system 520B (i.e. a game management system). The components of system 800 can be connected to each other in any suitable configuration, using any suitable type of connection. The components may be connected directly or over any suitable network. Client device 530, social networking system 520A, and game management system 520B can each have one or more corresponding data stores such as a local data store, social data store 845, and game data store 865, respectively. Social networking system 520A and game management system 520B can also have one or more servers that can communicate with client device 530 over an appropriate network. Social networking system 520A and game management system 520B can have, for example, one or more internet servers for communicating with client device 530 via the Internet. Similarly, social networking system 520A and game management system 520B can have one or more mobile servers for communicating with client device 530 via a mobile network (e.g., GSM, PCS, Wi-Fi, WPAN, etc.). In some embodiments, one server may be able to communicate with client device 530 over both the Internet and a mobile network. In other embodiments, separate servers can be used.

Client device 530 can receive and transmit data 823 to and from game management system 520B. This data can include, for example, webpages, messages, game inputs, game displays, HTTP packets, data requests, transaction information, updates, and other suitable data. At some other time, or at the same time, game management system 520B can communicate data 843, 847 (e.g., game state information, game system account information, page info, messages, data requests, updates, etc.) with other networking systems, such as social networking system 520A (e.g., Facebook, Myspace, etc.). Client device 530 can also receive and transmit data 827 to and from social networking system 520A. This data can include, for example, webpages, messages, social graph information, social network displays, HTTP packets, data requests, transaction information, updates, and other suitable data.

Communication between client device 530, social networking system 520A, and game management system 520B can occur over any appropriate electronic communication medium or network using any suitable communications protocols. For example, client device 530, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTPS, FTP, SNMP, TELNET, and a number of other protocols, may be used. In some embodiments, no protocol may be used and, instead, transfer of raw data may be utilized via TCP or User Datagram Protocol. In addition, a server in one interaction context may be a client in another interaction context. In some embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In some embodiments, a client request may cause a server to respond with a first data object, such as an HTML page, which itself refers to other data objects. A client application, such as a browser, will request these additional data objects as it parses or otherwise processes the first data object.

In some embodiments, an instance of an online game can be stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses an online game on game management system 520B, the BLOB containing the game state for the instance corresponding to the user can be transmitted to client device 530 for use by a client-side executed object to process. In some embodiments, the client-side executable may be a FLASH-based game, which can de-serialize the game state data in the BLOB. As a player plays the game, the game logic implemented at client device 530 maintains and modifies the various game state parameters locally. The client-side game logic may also batch game events, such as mouse clicks, and transmit these events to game management system 520B. Game management system 520B may itself operate by retrieving a copy of the BLOB from a database or an intermediate memory cache (memcache) layer. Game management system 520B can also de-serialize the BLOB to resolve the game state parameters and execute its own game logic based on the events in the batch file of events transmitted by the client to synchronize the game state on the server side. Game management system 520B may then re-serialize the game state, now modified, into a BLOB and pass this to a memory cache layer for lazy updates to a persistent database.

With a client-server environment in which the online games may run, one server system, such as game management system 520B, may support multiple client devices 530. At any given time, there may be multiple users at multiple client devices 530 all playing the same online game. In practice, the number of users playing the same game at the same time may be very large. As the game progresses with each user, multiple users may provide different inputs to the online game at their respective client devices 530, and multiple client devices 530 may transmit multiple user inputs and/or game events to game management system 520B for further processing. In addition, multiple client devices 530 may transmit other types of application data to game management system 520B.

In some embodiments, a computed-implemented game may be a text-based or turn-based game implemented as a series of web pages that are generated after a user selects one or more actions to perform. The web pages may be displayed in a web browser executed on client device 530. As an example, a client application downloaded to client device 530 may operate to serve a set of webpages to a player. As another example, a computer-implemented game may be an animated or rendered game executable as a stand-alone application or within the context of a webpage or other structured document. In some embodiments, the computer-implemented game may be implemented using Adobe Flash-based technologies. As an example, a game may be fully or partially implemented as a small web format (SWF) object that is embedded in a web page and executable by a Flash media player plug-in. In some embodiments, one or more described webpages may be associated with or accessed by social networking system 520A. This disclosure contemplates using any suitable application for the retrieval and rendering of structured documents hosted by any suitable network-addressable resource or website.

Application event data of a game is any data relevant to the game (e.g., user inputs). In some embodiments, each application datum may have a name and a value, and the value of the application datum may change (i.e., be updated) at any time. When an update to an application datum occurs at client device 530, either caused by an action of a user or by the game logic itself, client device 530 may need to inform game management system 520B of the update. For example, if the game is a farming game with a harvest mechanic (such as Zynga FarmVille), an event can correspond to a user clicking on a parcel of land to harvest a crop. In such an instance, the application event data may identify an event or action (e.g., harvest) and an object in the game to which the event or action applies. For illustration purposes, system 800 is discussed in reference to updating a game hosted on a network-addressable system (such as, for example, social networking system 520A or game management system 520B), where an instance of the online game is executed remotely on client device 530, which then transmits application event data to the hosting system such that the remote game server synchronizes game state associated with the instance executed by client device 530.

In some embodiments, one or more objects of a game may be represented as an Adobe Flash object. Flash may manipulate vector and raster graphics, and supports bidirectional streaming of audio and video. “Flash” may mean the authoring environment, the player, or the application files. In some embodiments, client device 530 may include a Flash client. The Flash client may be configured to receive and run Flash application or game object code from any suitable networking system (such as, for example, social networking system 520A or game management system 520B). In some embodiments, the Flash client may be run in a web browser executed on client device 530. A player can interact with Flash objects using client device 530 and the Flash client. The Flash objects can represent a variety of in-game objects. Thus, the user may perform various in-game actions on various in-game objects by making various changes and updates to the associated Flash objects. In some embodiments, in-game actions can be initiated by clicking or similarly interacting with a Flash object that represents a particular in-game object. For example, a user can interact with a Flash object to use, move, rotate, delete, attack, shoot, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at client device 530, the Flash client may send the events that caused the game state changes to the in-game object to game management system 520B. However, to expedite the processing and hence the speed of the overall gaming experience, the Flash client may collect a batch of some number of events or updates into a batch file. The number of events or updates may be determined by the Flash client dynamically or determined by game management system 520B based on server loads or other factors. For example, client device 530 may send a batch file to game management system 520B whenever 50 updates have been collected or after a threshold period of time, such as every minute.

As used herein, the term “application event data” may refer to any data relevant to a computer-implemented game application that may affect one or more game state parameters, including, for example and without limitation, changes to user data or metadata, changes to user social connections or contacts, user inputs to the game, and events generated by the game logic. In some embodiments, each application datum may have a name and a value. The value of an application datum may change at any time in response to the game play of a user or in response to the game engine (e.g., based on the game logic). In some embodiments, an application data update occurs when the value of a specific application datum is changed. In some embodiments, each application event datum may include an action or event name and a value (such as an object identifier). Thus, each application datum may be represented as a name-value pair in the batch file. The batch file may include a collection of name-value pairs representing the application data that have been updated at client device 530. In some embodiments, the batch file may be a text file and the name-vhalue pairs may be in string format.

In some embodiments, when a player plays a game on client device 530, game management system 520B may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular user and a particular online game. In some embodiments, while a player is not playing the game, the corresponding BLOB may be stored in the database. This enables a user to stop playing the game at any time without losing the current state of the game the user is in. When a user resumes playing the game next time, game management system 520B may retrieve the corresponding BLOB from the database to determine the most-recent values of the game-related data. In some embodiments, while a user is playing the online game, game management system 520B may also load the corresponding BLOB into a memory cache so that the game system may have faster access to the BLOB and the game-related data contained therein.

Systems and Methods

In some embodiments, one or more described user interfaces may be associated with a networking system or networking service. However, alternative embodiments may have application to the retrieval and rendering of structured documents hosted by any type of network addressable resource or web site. Additionally, as used herein, a user may be an individual, a group, or an entity (such as a business or third party application).

FIG. 9 illustrates an example of an architecture for computing system 900, which may be an implementation of server 522 or client system 530. In this example, computing system 900 comprises processor 902, cache memory 904, and one or more executable modules and drivers, stored on a tangible computer readable medium, directed to the functions described herein. Additionally, computing system 900 may include high-performance input/output (I/O) bus 906 and standard I/O bus 908. Host bridge 910 may couple processor 902 to high performance I/O bus 906, whereas I/O bus bridge 912 can couple buses 906 and 908 to each other. System memory 914 and one or more network/communication interfaces 916 may couple to bus 906. Computing system 900 may further include video memory (not shown) and a display device coupled to the video memory. Mass storage 918 and I/O ports 920 may couple to bus 908. Computing system 900 may optionally include a keyboard, a pointing device, and a display device (not shown) coupled to bus 908. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of computing system 900 are described in greater detail below. In particular, network interface 916 can provides communication between computing system 900 and any of a wide range of networks, such as an Ethernet (e.g., IEEE) network, a backplane, etc. Mass storage 918 can provide permanent storage for the data and programming instructions to perform the above-described functions implemented in servers 522, whereas system memory 914 (e.g., DRAM) provides temporary storage for the data and programming instructions when executed by processor 902. I/O ports 920 are one or more serial and/or parallel communication ports that provide communication between additional peripheral devices, which may be coupled to computing system 900.

Computing system 900 may include a variety of system architectures and various components of computing system 900 may be rearranged. For example, cache 904 may be on-chip with processor 902. Alternatively, cache 904 and processor 902 may be packed together as a “processor module,” with processor 902 being referred to as the “processor core.” Furthermore, certain embodiments of the present disclosure may not require nor include all of the above components. For example, the peripheral devices shown coupled to standard I/O bus 908 may couple to high performance I/O bus 906. In addition, in some embodiments, only a single bus may exist, with the components of computing system 900 being coupled to the single bus. Furthermore, computing system 900 may include additional components, such as additional processors, storage devices, or memories.

An operating system manages and controls the operation of computing system 900, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit. Some embodiments may operate in a wide area network environment, such as the Internet, including multiple network addressable systems.

On FIGS. 5A and 5B, network cloud 560 generally represents one or more interconnected networks, over which the systems and hosts described herein can communicate. Network cloud 560 may include packet-based wide area networks (such as the Internet), private networks, wireless networks, satellite networks, cellular networks, paging networks, and the like. As FIGS. 5A and 5B illustrate, some embodiments may operate in a network environment comprising one or more networking systems, such as social networking system 520A, game management system 520B, and one or more client devices 530. The components of social networking system 520A and game management system 520B operate analogously; as such, hereinafter they may be referred to simply at networking system 520. Client devices 530 are operably connected to the network environment via a network service provider, a wireless carrier, or any other suitable means.

Networking system 520 is a network addressable system that, in various example embodiments, comprises one or more physical servers 522 and data stores 524. The one or more physical servers 522 are operably connected to computer network 560 via, by way of example, a set of routers and/or networking switches 526. In an example embodiment, the functionality hosted by the one or more physical servers 522 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 522 may host functionality directed to the operations of networking system 520. Hereinafter servers 522 may be referred to as server 522, although server 1222 may include numerous servers hosting, for example, networking system 520, as well as other content distribution servers, data stores, and databases. Data store 524 may store content and data relating to, and enabling, operation of networking system 520 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 524 corresponds to one or more of a variety of separate and integrated databases, such as relational databases and object-oriented databases, that maintain information as an integrated collection of logically related records or files stored on one or more physical systems. Structurally, data store 524 may generally include one or more of a large class of data storage and management systems. In some embodiments, data store 524 may be implemented by any suitable physical system(s) including components, such as one or more database servers, mass storage media, media library systems, storage area networks, data storage clouds, and the like. In one example embodiment, data store 524 includes one or more servers, databases (e.g., MySQL), and/or data warehouses. Data store 524 may include data associated with different networking system 520 users and/or client devices 530.

Client device 530 is generally a computer or computing device including functionality for communicating (e.g., remotely) over a computer network. Client device 530 may be a desktop computer, laptop computer, personal digital assistant (PDA), in- or out-of-car navigation system, smart phone or other cellular or mobile phone, or mobile gaming device, among other suitable computing devices. Client device 530 may execute one or more client applications, such as a web browser (e.g., Microsoft Internet Explorer, Mozilla Firefox, Apple Safari, Google Chrome, and Opera), to access and view content over a computer network. In some embodiments, the client applications allow a user of client device 530 to enter addresses of specific network resources to be retrieved, such as resources hosted by networking system 520. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client device 530 desires to view a particular webpage (hereinafter also referred to as target structured document) hosted by networking system 520, the user's web browser, or other document Sequence Generator or suitable client application, formulates and transmits a request to networking system 520. The request generally includes a URL or other document identifier as well as metadata or other information. By way of example, the request may include information identifying the user, such as a user ID, as well as information identifying or characterizing the web browser or operating system running on the user's client computing device 730. The request may also include location information identifying a geographic location of the user's client system or a logical network location of the user's client system. The request may also include a timestamp identifying when the request was transmitted.

Although the example network environment described above and illustrated in FIGS. 5A and 5B described with respect to social networking system 520A and game management system 520B, this disclosure encompasses any suitable network environment using any suitable systems. As an example, the network environment may include online media systems, online reviewing systems, online search engines, online advertising systems, or any combination of two or more such systems.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Although the above example embodiments described as being implemented via a web browser on a client device, it is to be noted that a game display may in some embodiments be provided by a virtual reality (VR) display or an augmented reality (AR) display. AR comprises a live direct or indirect view of a physical, real-world environment whose elements are augmented (or supplemented) by computer-generated sensory input such as sound, video, graphics or GPS data. It is related to a more general concept called mediated reality, in which a view of reality is modified (possibly even diminished rather than augmented) by a computer. As a result, the technology functions by enhancing one's current perception of reality. An augmented reality gaming device may allow users to interact with visual elements thus overlaid on the view of reality. Augmentation may be performed in real-time and may comprise overlaying on the view of reality one or more user interface elements that can be selected a manipulated by the user, and may further comprise overlaying on the view of reality game objects and/or character with which the user can interact during gameplay.

Virtual Reality (VR), which can be referred to as immersive multimedia or computer-simulated life, replicates an environment that simulates physical presence in places in the real world or imagined worlds and lets the user interact in that world. Virtual reality artificially creates sensory experiences, which can include sight, hearing, touch, smell, taste, and more. Virtual reality environments can be displayed either on a computer screen or with special stereoscopic displays, and some simulations include additional sensory information and focus on real sound through speakers or headphones targeted towards VR users. Some advanced, haptic, systems now include tactile information, generally known as force feedback in medical, gaming and military applications. Furthermore, virtual reality covers remote communication environments which provide virtual presence of users with the concepts of telepresence and telexistence or a virtual artifact (VA) either through the use of standard input devices such as a keyboard and mouse, or through multimodal devices such as a wired glove or omnidirectional treadmills. The simulated gaming environment displayed to the user by use of a virtual reality gaming device can for some games be similar to the real world in order to create a lifelike experience, while the virtual gaming environment seemingly inhabited by the player during VR gameplay may in other embodiments be stylized environments that differ significantly from reality.

In conventional online game systems, a game state information temporally stored on the client device is periodically synced based on an authoritative game state information maintained at the game server. Therefore, conventional online game systems do not allow off-line changes in game state information to be made during off-line inter-device communication. As described above, some embodiments allow off-line changes in game state information (and particularly player state information indicating changes in the inventory of game objects owned by the user) to be made during off-line inter-device communication (causing changes in localized game state information for both gifting and receiving device), with subsequent syncing of the game state information maintained at the game server based on the game state information stored on the client device(s).

### Miscellaneous

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the invention can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

1. A computer implemented method comprising:
generating, by a first client device executing a computer-implemented online game in an off-line mode in which gameplay is executed without communication with a game server managing the game, a request for a virtual object from a second client device;
sending the request for the virtual object, by the first client device, using an off-line communication channel;
based on receiving over the off-line communication channel a response including the requested virtual object from a second client device executing the game, updating a game state for the game on the first client device to indicate receipt of the virtual object from the second client device.

2. The method of claim 1, further comprising:
updating a social network state between a first user associated with the first client device and a second user associated with the second client device.

3. The method of claim 1, further comprising:
causing display of a first interactive element on a user interface of the first client device alongside a gifting icon;
wherein the request for the virtual object is generated based on detecting an interaction with the first interactive element, and wherein the request for the virtual object is sent by the first client device as a broadcast message.

4. The method of claim 1, further comprising:
causing display of a first interactive element on a user interface of the first client device alongside a gifting icon;
based on detecting an interaction with the first interactive element, broadcasting a discovery message, by the first client device, using the off-line communication channel;
based on receiving a response to the discovery message, from the second client device, over the off-line communication channel, causing display of a second interactive element associated to the second client device on the user interface of the first client device; and
wherein the request for the virtual object is generated based on detecting an interaction with the second interactive element.

5. The method of claim 4, wherein the position of the second interactive element on the user interface is indicative of the relative physical position of the second client device to the first client device.

6. The method of claim 1, wherein sending the request for the virtual object, by the first client device, using an off-line communication channel comprises:
periodically sending the request for the virtual object, by the first client device, using different off-line communication channels, until the first client device receives a response including the requested virtual object from the second client device.

7. The method of claim 1, wherein sending the request for the virtual object, by the first client device, using an off-line communication channel comprises:
periodically sending the request for the virtual object, by the first client device, using different off-line communication channels, until the first client device receives a response including the requested virtual object from the second client device.

8. The method of claim 1, wherein the request for the virtual object is sent by the first client device by executing an off-line communication protocol, the method further comprising:
generating a personal area network, by the first client device, the personal area network being only available to client devices executing the off-line communication protocol, and wherein the off-line communication channel is established over the personal area network.

9. A computer system comprising:
a memory to store computer executable instructions;
at least one computer processor coupled to the memory to execute the instruction, that upon execution perform operations comprising:
generating, by a first client device executing a game in an off-line mode, a request for a virtual object from a second client device;
sending the request for the virtual object, by the first client device, using an off-line communication channel;
based on receiving a response including the requested virtual object from a second client device over the off-line communication channel, updating a game state for the game on the first client device to indicate receipt of the virtual object from the second client device.

10. The system of claim 9, wherein the operations further comprises:
updating a social network state between a first user associated with the first client device and a second user associated with the second client device.

11. The system of claim 9, wherein the operations further comprises:
causing display of a first interactive element on a user interface of the first client device alongside a gifting icon; and
wherein the request for the virtual object is generated based on detecting an interaction with the first interactive element, and wherein the request for the virtual object is sent by the first client device as a broadcast message.

12. The system of claim 9, wherein the operations further comprises:
causing display of a first interactive element on a user interface of the first client device alongside a gifting icon;
based on detecting an interaction with the first interactive element, broadcasting a discovery message, by the first client device, using the off-line communication channel;
based on receiving a response to the discovery message, from the second client device, over the off-line communication channel, causing display of a second interactive element associated to the second client device on the user interface of the first client device; and
wherein the request for the virtual object is generated based on detecting an interaction with the second interactive element.

13. The system of claim 12, wherein the position of the second interactive element on the user interface is indicative of the relative physical position of the second client device to the first client device.

14. The system of claim 9, wherein sending the request for the virtual object, by the first client device, using an off-line communication channel comprises:
periodically sending the request for the virtual object, by the first client device, using the same off-line communication channel, until the first client device receives a response including the requested virtual object from the second client device.

15. The system of claim 9, wherein the request for the virtual object is sent by the first client device by executing an off-line communication protocol, the method further comprising:
generating a personal area network, by the first client device, the personal area network being only available to client devices executing the off-line communication protocol, and wherein the off-line communication channel is established over the personal area network.

16. A non-transitory computer-readable medium storing instructions thereon, which when executed by a processor cause a computer system to perform operations comprising:
generating, by a first client device executing a game in an off-line mode, a request for a virtual object from a second client device;
sending the request for the virtual object, by the first client device, using an off-line communication channel;
based on receiving a response including the requested virtual object from a second client device over the off-line communication channel, updating a game state for the game on the first client device to indicate receipt of the virtual object from the second client device.

17. A method comprising:
receiving, by a first client device executing an off-line communication protocol, a request for a virtual object from a second client device over an off-line communication channel;
sending a response including the requested virtual object from the first client device to the second client device over the off-line communication channel;
updating a social network state between a first user associated with the first client device and a second user associated with the second client device.

18. The method of claim 17, wherein sending the response including the requested virtual object comprises:
periodically sending the response including the requested virtual object over the off-line communication channel until the first client device receives acknowledgement of receipt of the requested virtual object from the second client device; and
wherein the social network state between the first user associated with the first client device and the second user associated with the second client device is updated upon receiving the acknowledgement of receipt of the requested virtual object from the second client device.

19. The method of claim 17, wherein the first client device executes the game in an off-line mode.

20. The method of claim 17, wherein the first client device executes the off-line communication protocol in a background mode.
